(19) United States
(12) Patent Application Publication
(10) Pub. No.: US 2024/0317212 A1
(43) Pub. Date: Sep. 26, 2024

(54) CONTROL DEVICE FOR HYBRID VEHICLE

(71) Applicant: MITSUBISHI JIDOSHA KOGYO KABUSHIKI KAISHA, Tokyo (JP)

(72) Inventors: Kazumichi TAKAHASHI, Tokyo (JP); Hideo MATSUNAGA, Tokyo (JP); Yoshikazu MATSUDA, Tokyo (JP); Masanori AIHARA, Tokyo (JP)

(73) Assignee: MITSUBISHI JIDOSHA KOGYO KABUSHIKI KAISHA, Tokyo (JP)

(21) Appl. No.: 18/580,467

(22) PCT Filed: May 27, 2022
(86) PCT No.: PCT/JP2022/021689

§ 371 Date: Jan. 18, 2024

(30) Foreign Application Priority Data
Jul. 19, 2021 (JP) 2021-118853

(51) Int. Cl. B60W 20/50; B60W 10/06; F02D 41/06; F02M 26/49

(52) U.S. Cl. CPC B60W 20/50; B60W 10/06; F02D 41/068; F02M 26/49; B60W 2510/068; B60W 2510/244; B60W 2710/0644; F02D 2200/0802; F02D 2200/503

(57) ABSTRACT

A control device for a hybrid vehicle determines whether an EGR valve has an opening failure, and performs a pre-operation in which the engine is operated at a load smaller than a load in a series mode for a certain period of time while the vehicle is driven by a motor immediately before switching from an EV mode to the series mode. The pre-operation has a normal pre-mode in which the engine is operated at a first load when it is determined that the EGR valve does not have an opening failure, and a small failure pre-mode and a large failure pre-mode in which the engine is operated at a second load larger than the first load when it is determined that the EGR valve has the opening failure.

### TECHNICAL FIELD

The present invention relates to a failure determination of an exhaust gas recirculation system and a control technique for an engine.

### BACKGROUND ART

Many engines provided in a vehicle are provided with an exhaust gas recirculation (EGR) system in order to improve the exhaust performance. The EGR system includes, for example, an exhaust gas recirculation passage (an EGR passage) that recirculates a part of exhaust gas (EGR gas) from an exhaust passage to an intake passage, and an exhaust gas recirculation valve (an EGR valve) that adjusts the opening degree of the EGR passage. The opening degree of the EGR valve is controlled by a control unit or the like based on an operating state of the engine.

Patent Literature 1 discloses a technique for determining whether an EGR valve of an engine in a hybrid vehicle is stuck open and stabilizing the operation of an engine when the EGR valve is stuck open. In Patent Literature 1, the EGR valve of the engine is provided with an opening degree sensor, and it is determined whether the EGR valve is stuck open based on a difference between an opening degree Command value of the EGR valve and an actual opening degree of the EGR valve detected by the opening degree sensor. Then, when it is determined that the EGR valve is stuck open, the operating line (the load) of the engine is increased as compared to normal to stabilize the operation of the engine.

### CITATION LIST

### Patent Literature

Patent Literature 1: JP2014-077363A

### SUMMARY OF INVENTION

### Technical Problem

In Patent Literature 1, since the engine load is constantly increased when it is determined that the EGR valve is stuck open, the fuel efficiency may deteriorate. As in Patent Literature 1, when the increase in engine load is controlled in a parallel mode in which the output of the engine is mechanically used for a traveling driving force, traveling may be affected. When a motor (an electric motor) is controlled so as to control the increase in engine load and reduce the influence on traveling, the control of the motor may be complicated.

The present invention has been made in view of such a problem, and an object of the present invention is to provide a control device for a hybrid vehicle for improving the stability of an engine operation without affecting traveling even if an EGR valve fails.

### Solution to Problem

In order to achieve the object described above, the present invention provides a control device for a hybrid vehicle, the hybrid vehicle including an engine including an exhaust gas recirculation system configured to guide a part of exhaust gas from an exhaust passage to an intake passage, a storage battery, a generator driven by the engine to generate electric power, an electric motor configured to drive the vehicle by electric power supplied from at least one of the generator and the storage battery, and a traveling mode switching control unit configured to switch, based on a required output required for the vehicle, between a first traveling mode in which the electric motor is driven by electric power supplied from the storage battery with the engine stopped, and a second traveling mode in which the vehicle travels while causing the generator to generate electric power at a predetermined load or larger by a driving force of the operated engine. The control device includes: a failure determination unit configured to determine whether an exhaust gas recirculation valve that adjusts a flow rate of the exhaust gas flowing into the exhaust gas recirculation system has a failure; and a control unit configured to perform a warm-up operation in which the engine is operated at a first load smaller than the predetermined load while the vehicle is driven by the electric motor before switching from the first traveling mode to the second traveling mode. The warm-up operation has a normal warm-up operation mode in which the engine is operated at the first load when the failure determination unit determines that the exhaust gas recirculation valve does not have the failure, and a failure warm-up operation mode in which the engine is operated at an engine load increased to a second load larger than the first load and smaller than the predetermined load when the failure determination unit determines that the exhaust gas recirculation valve has the failure.

Accordingly, by performing the warm-up operation in which the engine is operated at the first load smaller than the predetermined load before switching from the first traveling mode to the second traveling mode in which the engine is operated at the predetermined load, it is possible to improve the stability and the exhaust performance of the engine operation immediately after switching to the second traveling mode. When the vehicle is driven by the electric motor during the warm-up operation, the traveling performance can be ensured regardless of the control of the engine.

When it is determined that the exhaust gas recirculation valve has a failure, the engine is operated at the second load higher than the first load set when it is determined that the exhaust gas recirculation valve does not have a failure in the warm-up operation. Therefore, even if the exhaust gas recirculation valve has a failure, the stability of the engine operation can be improved.

Preferably, an exhaust purification catalyst is provided in the exhaust passage, the control device further includes a catalyst temperature detection unit configured to detect a temperature of the exhaust purification catalyst, and the control unit ends the failure warm-up operation mode when the temperature of the exhaust purification catalyst becomes equal to or higher than a predetermined temperature during execution of the warm-up operation.

Accordingly, when the temperature of the exhaust purification catalyst becomes equal to or higher than the predetermined temperature, even if it is determined that the exhaust gas recirculation valve has a failure, the failure warm-up operation mode is ended. Therefore, the engine load is not increased more than necessary in order to activate the exhaust purification catalyst in the warm-up operation, and the fuel efficiency can be improved.

Preferably, the control unit controls a rotation speed of the engine to be constant for a predetermined period of time in the warm-up operation.

Accordingly, it is possible to prevent a variation in the engine speed in the warm-up operation and improve the quietness.

Preferably, the failure determination unit estimates an opening degree of the exhaust gas recirculation valve when determining that the exhaust gas recirculation valve has the failure. The control unit sets an increased amount of the engine load in the failure warm-up operation mode with respect to the normal warm-up operation mode in accordance with the opening degree of the exhaust gas recirculation valve when determined that the exhaust gas recirculation valve is in the failure.

Accordingly, the amount of increase in the engine load is set in the failure warm-up operation mode according to the opening degree of the exhaust gas recirculation valve when it is determined that the exhaust gas recirculation valve has a failure. Therefore, the engine can be appropriately warmed up according to the failure mode of the exhaust gas recirculation valve.

Preferably, the control unit increases the engine load by increasing at least an output of the generator in the failure warm-up operation mode.

Accordingly, by increasing the engine load in the failure warm-up operation mode, it is possible to increase the electric power supplied to the motor or the storage battery and to prevent a decrease in state of charge of the storage battery.

Preferably, during execution of the warm-up operation, when the required output of the engine becomes higher than an output of the engine in the warm-up operation, the control unit forcibly stops the warm-up operation and operatively controls the engine based on the required output of the engine.

Accordingly, when the required output of the engine becomes high during the warm-up operation, the engine can be warmed up more quickly by increasing the engine load than by continuing the warm-up operation.

Preferably, in the failure warm-up operation mode, when an exhaust gas recirculation amount set based on the required output of the engine is larger than a sum of an exhaust gas recirculation amount at a time of a failure and an increased amount of the exhaust gas recirculation amount depending on an increased amount of the engine load, the control unit stops the failure warm-up operation mode.

Accordingly, when the required output of the engine becomes high and the exhaust gas recirculation amount increases during the warm-up operation, even if the exhaust gas recirculation valve has a failure, the engine can be warmed up more quickly by increasing the engine load than by continuing the warm-up operation.

Preferably, the control device for the hybrid vehicle further includes a state-of-charge estimation unit configured to estimate a state of charge of the storage battery, the traveling mode switching control unit switches to the second traveling mode when the state of charge of the storage battery becomes equal to or less than a first predetermined value in the first traveling mode, and the warm-up operation is started when the state of charge of the storage battery becomes equal to or less than a second predetermined value higher than the first predetermined value.

Accordingly, before the state of charge of the storage battery decreases and the first traveling mode switches to the second traveling mode, the engine is started and the warm-up operation is performed. Therefore, it is possible to warm up the engine while ensuring the traveling performance in the first traveling mode, and to improve the stability and the exhaust performance of the engine operation immediately after switching to the second traveling mode. Further, even if the exhaust gas recirculation valve fails in the warm-up operation, the engine load is increased to promote the warming, and the stability and the exhaust performance of the engine operation can be improved.

### Advantageous Effects of Invention

According to the control device for a hybrid vehicle in the present invention, immediately before switching from the first traveling mode to the second traveling mode, the engine is started and the warm-up operation is performed. At this time, when it is determined that the exhaust gas recirculation valve has a failure, the engine is operated at a higher load than that when it is determined that the exhaust gas recirculation valve does not have a failure. Therefore, it is possible to quickly raise the engine temperature while ensuring the stability of the engine operation.

By performing a high-load operation in the warm-up operation, it is possible to effectively increase the engine temperature in a state in which the engine temperature is low, and it is possible to improve the fuel efficiency by reducing the unnecessary high-load operation in a situation in which the engine temperature is rising.

### BRIEF DESCRIPTION OF DRAWINGS

FIG. 1 is a schematic configuration diagram of a traveling drive system of a vehicle according to an embodiment of the present invention.

FIG. 2 is a configuration diagram of a failure diagnosis device for a gas supply and exhaust system and an EGR system of an engine, and an EGR opening failure engine control device according to the present embodiment.

FIG. 3 is a flowchart showing a procedure of failure determination control in the failure diagnosis device for the EGR system.

FIG. 4 is a time chart showing an example of an operation of the EGR valve and the transition of the intake manifold pressure in first failure determination control when the EGR system is in a normal state.

FIG. 5 is a time chart showing an example of an operation of the EGR valve and the transition of the intake manifold pressure and the EGR temperature in the first failure determination control and second failure determination control when the EGR system is in a failure state.

FIG. 6 is a flowchart showing an engine control procedure when an EGR opening failure occurs.

FIG. 7 is a time chart showing an example of the engine load set in a small failure pre-mode.

### DESCRIPTION OF EMBODIMENTS

Hereinafter, an embodiment of the present invention will be described with reference to the drawings.

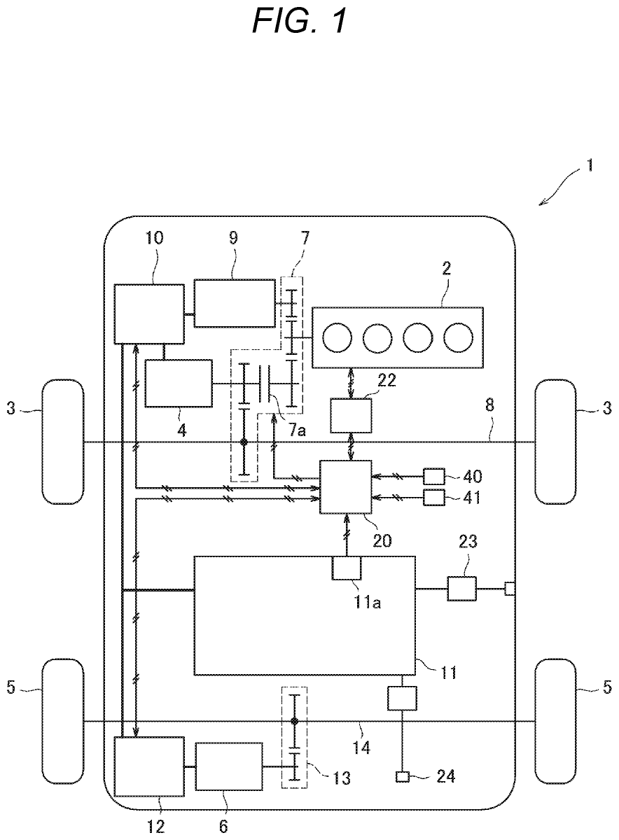

FIG. 1 is a schematic configuration diagram of a plug-in hybrid vehicle (hereinafter referred to as a vehicle 1) according to an embodiment of the present invention.

As shown in FIG. 1, the vehicle 1 including a failure diagnosis device for an EGR system according to the present embodiment is a four-wheel drive vehicle that can travel by driving a front wheel 3 using the output of an engine 2 and that includes an electric front motor 4 (an electric motor) and an electric rear motor 6 (an electric motor). The electric front motor 4 drives the front wheel 3, and the electric rear motor 6 drives a rear wheel 5.

The engine 2 can drive a drive shaft 8 of the front wheel 3 via a speed reducer 7, and can generate electric power by driving a motor generator 9 (a generator) via the speed reducer 7.

The front motor 4 is driven by being supplied with high voltage electric power via a front inverter 10 from an in-vehicle battery 11 (a storage battery) and the motor generator 9 that are mounted on the vehicle 1, and drives the drive shaft 8 of the front wheel 3 via the speed reducer 7. The speed reducer 7 includes a built-in clutch 7a that can connect and disconnect power transmission between an output shaft of the engine 2 and the drive shaft 8 of the front wheel 3.

The rear motor 6 is driven by being supplied with high voltage electric power via a rear inverter 12 from the in-vehicle battery 11 and the motor generator 9, and drives a drive shaft 14 of the rear wheel 5 via a speed reducer 13.

The electric power generated by the motor generator 9 can charge the in-vehicle battery 11 via the front inverter 10, and can be supplied to the front motor 4 and the rear motor 6.

The in-vehicle battery 11 is implemented by a secondary battery such as a lithium ion battery, and includes a battery module (not shown) collectively including a plurality of battery cells. The in-vehicle battery 11 includes a monitoring unit 11a (a state-of-charge estimating unit) that monitors a state of the battery module such as a voltage, the state of charge, and a temperature of the battery module, and that estimates (detects) the state of charge of the in-vehicle battery 11 as a whole.

The front inverter 10 has a function of controlling the output of the front motor 4 based on a control signal from a hybrid control unit 20 (a traveling mode switching control unit) and controlling the output of the motor generator 9 based on a control signal from the hybrid control unit 20.

The rear inverter 12 has a function of controlling the output of the rear motor 6 based on a control signal from the hybrid control unit 20.

The vehicle 1 includes an engine control unit 22 (a control unit) that drives and controls the engine 2, and a charger 23 that charges the in-vehicle battery 11 with an external power source.

The vehicle 1 includes an external outlet 24 for supplying electric power from the in-vehicle battery 11 to the outside.

The hybrid control unit 20 is a comprehensive control device that controls the traveling of the vehicle 1, and includes an input and output device, a storage device (a read only memory (ROM), a random access memory (RAM), a non-volatile RAM, and the like), a central processing unit (CPU), a timer, and the like. The engine control unit 22 also includes an input and output device, a storage device (a ROM, a RAM, a non-volatile RAM, and the like), a central processing unit (CPU), a timer, and the like.

An input side of the hybrid control unit 20 is connected with the monitoring unit 11a of the in-vehicle battery 11, the front inverter 10, the rear inverter 12, the engine control unit 22, an accelerator opening sensor 40 that detects an accelerator operation amount, and a vehicle speed sensor 41 that detects a traveling speed of the vehicle 1. Detection, activation and operation information from these devices are input to the hybrid control unit 20.

On the other hand, an output side of the hybrid control unit 20 is connected with the front inverter 10, the rear inverter 12, the speed reducer 7 (the clutch 7a), and the engine control unit 22.

The hybrid control unit 20 calculates a vehicle request output and a driving torque that are necessary for driving the vehicle 1 based on the above-described various detection amounts and various types of operation information of the accelerator opening sensor 40, the vehicle speed sensor 41, and the like, transmits a control signal to the engine control unit 22, the front inverter 10, the rear inverter 12, and the speed reducer 7, and controls the switching of traveling modes (an electric vehicle mode (an EV mode), a series mode, and a parallel mode), the outputs of the engine 2, the front motor 4, and the rear motor 6, and the output of the motor generator 9.

In the EV mode, the engine 2 is stopped, and the front motor 4 and the rear motor 6 are driven by electric power supplied from the in-vehicle battery 11 to drive the vehicle 1.

In the series mode, the clutch 7a of the speed reducer 7 is disconnected, and the motor generator 9 is operated by the engine 2. Then, the front motor 4 and the rear motor 6 are driven by the electric power generated by the motor generator 9 and the electric power supplied from the in-vehicle battery 11 to cause the vehicle to travel. In the series mode, a rotation speed of the engine 2 is set to a predetermined rotation speed, and surplus electric power is supplied to the in-vehicle battery 11 to charge the in-vehicle battery 11.

In the parallel mode, the clutch 7a of the speed reducer 7 is connected, and power is mechanically transmitted from the engine 2 via the speed reducer 7 to drive the front wheel 3. The front motor 4 and the rear motor 6 are driven by the electric power generated by operating the motor generator 9 by the engine 2 and the electric power supplied from the in-vehicle battery 11 to cause the vehicle to travel.

In the present embodiment, the EV mode corresponds to a first traveling mode according to the present invention, and the series mode or the parallel mode corresponds to a second traveling mode according to the present invention.

The hybrid control unit 20 sets the traveling mode to the parallel mode in a region where the engine 2 is efficient, such as a high-speed region. In a region other than the parallel mode, that is, in a medium or low speed region, the mode is switched between the EV mode and the series mode based on the drive torque of the vehicle 1 and the state of charge (SOC) of the in-vehicle battery 11.

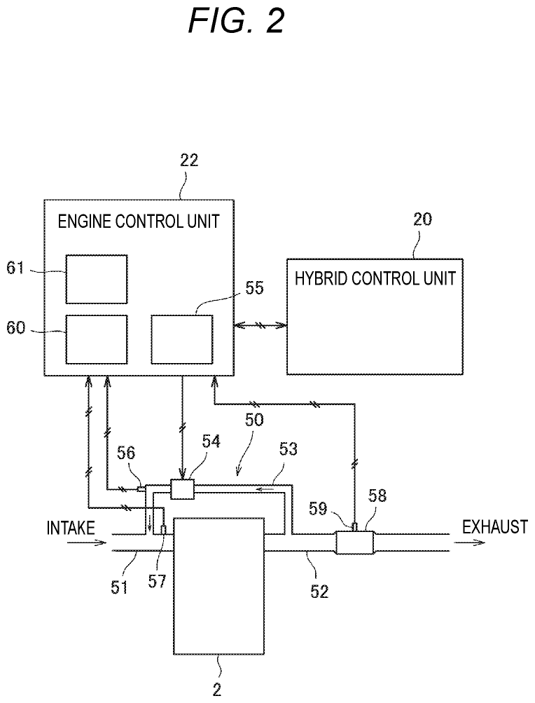

FIG. 2 is a configuration diagram of a failure diagnosis device for a gas supply and exhaust system and an exhaust gas recirculation system 50 (an EGR system) of the engine 2, and an EGR opening failure engine control device.

As shown in FIG. 2, the engine 2 is provided with the EGR system 50. The EGR system 50 includes an exhaust gas recirculation passage 53 (an EGR passage) that communicates an intake passage 51 of the engine 2 with an exhaust passage 52 of the engine 2, an exhaust gas recirculation valve 54 (an EGR valve) that adjusts the opening degree of the EGR passage 53, and an EGR control unit 55 that controls the opening degree of the EGR valve 54.

The EGR control unit 55 is provided in the engine control unit 22. The EGR control unit 55 controls the opening degree of the EGR valve 54 based on an operating state of the engine 2, for example, the required output of the engine 2 based on the accelerator operation amount.

An EGR temperature sensor 56 that detects the temperature of exhaust gas recirculation gas (EGR gas) is provided in the EGR passage 53. The EGR temperature sensor 56 is provided on an intake passage 51 side with respect to the EGR valve 54, and detects the temperature of the EGR gas, which is a part of the exhaust gas flowing from the exhaust passage 52 to the intake passage 51 through the EGR valve 54.

An exhaust purification catalyst 58 such as a three-way catalyst is provided in the exhaust passage 52 of the engine 2. Further, the exhaust purification catalyst 58 is provided with a catalyst temperature sensor 59 (a catalyst temperature detection unit) that detects the catalyst temperature.

The engine control unit 22 is provided with an EGR failure determination unit 60 (a failure determination unit) that diagnoses malfunction of the EGR system 50, specifically determines malfunction of the EGR valve 54.

The EGR failure determination unit 60 controls the operation of the EGR valve 54 and executes EGR failure determination control based on a change in intake pressure detected by an intake manifold pressure sensor 57 and a change in temperature of the EGR gas detected by the EGR temperature sensor 56. The EGR failure determination unit 60 controls the operation of the EGR valve 54 and determines a failure of the EGR valve 54 based on the changes in temperature and pressure of the EGR gas.

Further, the engine control unit 22 includes an engine load correction unit 61 that executes control to increase the engine load during subsequent engine startup when it is determined that the EGR valve 54 has an opening failure.

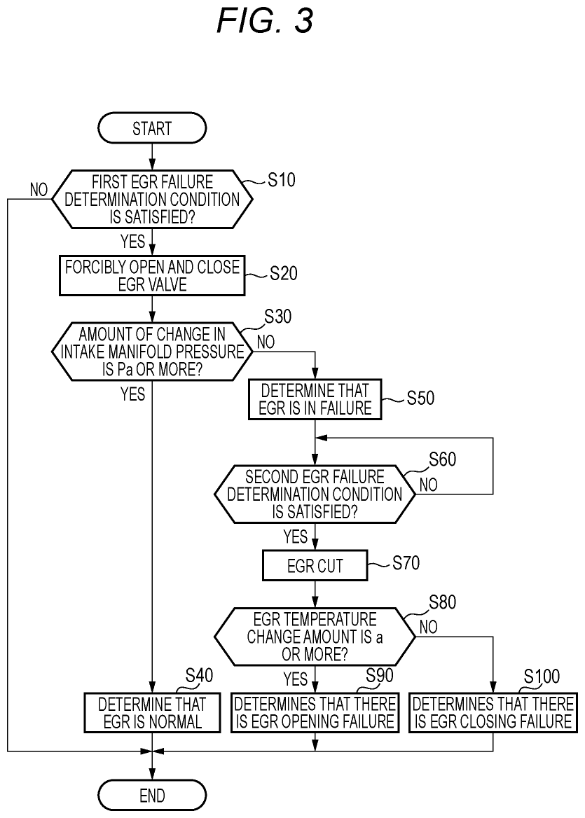

Next, the failure determination control for the EGR valve 54 will be described with reference to FIGS. 3 to 5.

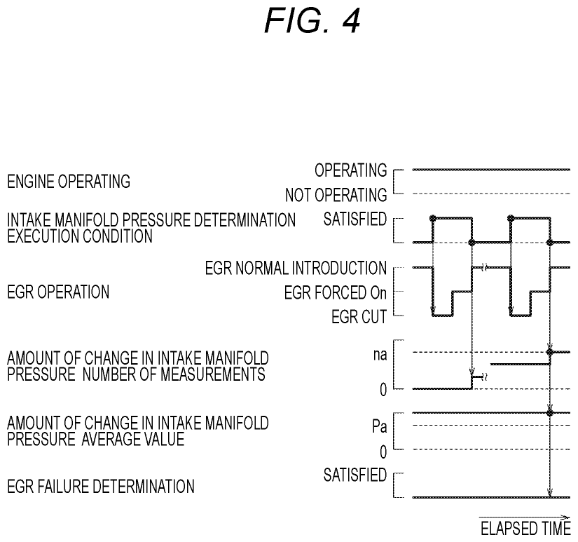

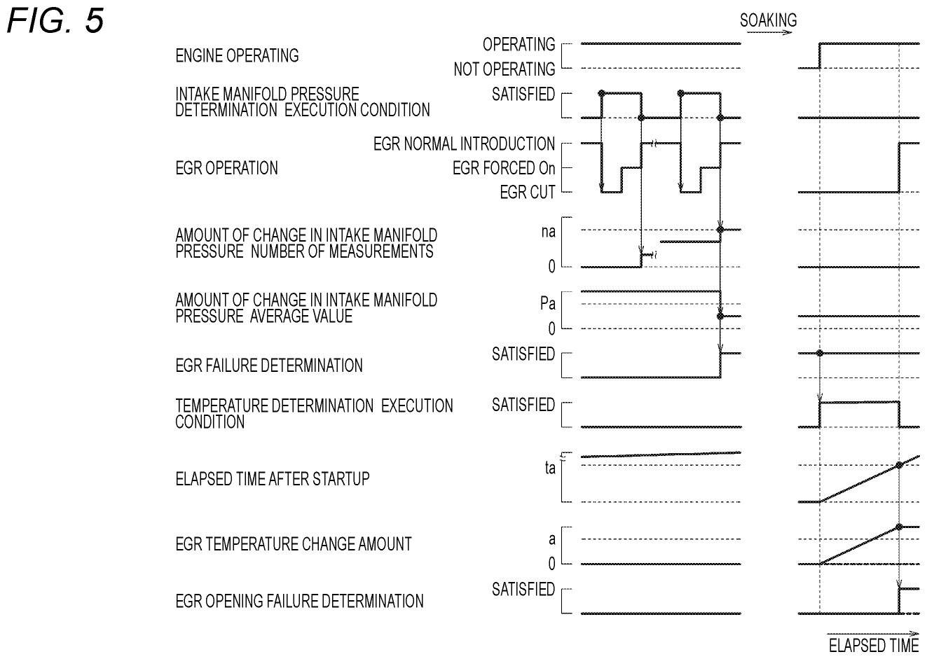

FIG. 3 is a flowchart showing a procedure of the EGR failure determination control executed by the EGR failure determination unit 60. FIG. 4 is an example of a time chart showing an operation of the EGR valve 54 and the transition of the intake manifold pressure in first failure determination control when the EGR system is in a normal state. FIG. 5 is an example of a time chart showing an operation of the EGR valve 54 and the transition of the intake manifold pressure and the EGR temperature in the first failure determination control and second failure determination control when the EGR system 50 is in a failure state. In an EGR temperature change amount in FIG. 5, a solid line indicates a time when the EGR valve 54 has an opening failure, and a broken line indicates a time when the EGR valve 54 has a closing failure.

The EGR failure determination control is repeatedly executed at predetermined intervals, for example, when the engine is operating.

As shown in FIG. 3, first, in step S10, the EGR failure determination unit 60 determines whether a first EGR failure determination condition is satisfied (ON). The first EGR failure determination condition is a condition for determining a failure of the EGR valve 54 by the first failure determination control, is an engine operating state such as an idling operation or a deceleration operation, and is a time of a steady operation with a constant engine load and rotation speed. When the first EGR failure determination condition is satisfied (ON) (Yes in step S10), the process proceeds to step S20. When the first EGR failure determination condition is not satisfied (OFF) (No in step S10), this routine ends.

In step S20, the EGR failure determination unit 60 forcibly opens and closes the EGR valve 54. Specifically, first, the EGR failure determination unit 60 forcibly fully closes the EGR valve 54 (EGR cut). At this time, the intake pressure is detected by the intake manifold pressure sensor 57 and stored in the storage device. Then, the EGR failure determination unit 60 forcibly opens the EGR valve to a predetermined opening degree (for example, fully open) after a predetermined period of time (for example, several seconds) has elapsed (EGR forced ON). Then, the EGR failure determination unit 60 detects the intake pressure by the intake manifold pressure sensor 57 when a predetermined time (for example, several seconds) has elapsed during which the intake pressure becomes stable in a state of the EGR forced ON, and calculates the amount of change in intake manifold pressure, which is a difference from the intake pressure detected at the start of the EGR cut.

Then, the EGR failure determination unit 60 executes the opening and closing control of the EGR valve 54 and the measurement of the amount of change in intake manifold pressure a predetermined number of times na (for example, three times), and calculates an average value of the amounts of change in intake manifold pressure per time. In a predetermined period of time (for example, several seconds) between the measurements of the amount of change in intake manifold pressure, the condition for determining the intake manifold pressure is not satisfied, and the EGR opening degree is controlled based on the operating state of the engine 2 (EGR normal introduction). The EGR failure determination unit 60 stores the calculated average value of the amounts of change in intake manifold pressure per time in the storage device. Then, the process proceeds to step S30.

In step S30, the EGR failure determination unit 60 determines whether the average value of the amounts of change in intake manifold pressure calculated in step S20 is equal to or greater than a predetermined value Pa (a predetermined threshold value). The predetermined value Pa may be set to be in the vicinity of a lower limit value of the amount of change in intake pressure when the EGR valve 54 opens and closes in a normal state. When the amount (the average value) of change in intake manifold pressure is equal to or greater than the predetermined value Pa (Yes in step S30), the process proceeds to step S40. When the amount (the average value) of change in intake manifold pressure is less than the predetermined value Pa (No in step S30), the process proceeds to step S50.

In step S40, the EGR failure determination unit 60 determines that the EGR system 50 is normal. Then, this routine ends.

In step S50, the EGR failure determination unit 60 determines that the EGR system 50 is in failure. Then, the process proceeds to step S60.

In step S60, the EGR failure determination unit 60 determines whether the second EGR failure determination condition is satisfied (ON). The second EGR failure determination condition is a condition for determining a failure of the EGR valve 54 by the second failure determination control, and is, for example, a time of the engine startup after soaking. For example, the hybrid control unit 20 of the vehicle 1 may be provided with a timer (a stop time measurement unit) that measures the engine stop time, and it may be determined that the soaking is completed when the engine has been stopped for a predetermined period of time (for example, 6 hours). The engine stop time may be, for example, the duration of a power off state of the vehicle. However, when the vehicle can travel for a long time in the EV mode, the second EGR failure determination condition is also satisfied after the soaking during a pre-operation (a warm-up operation) immediately after the engine 2 is started to shift to the series mode from a state in which the EV mode is continued for a predetermined period of time. In the pre-operation, the engine 2 is operated at a low rotation speed and a low load for a predetermined period of time to increase the temperature (based on, for example, the water temperature and the exhaust temperature) of the engine 2 and stabilize the engine operation. After the pre-operation is completed, the engine is operated according to the required load and the like.

When the second EGR failure determination condition is satisfied (ON) (Yes in step S60), the process proceeds to step S70. When the second EGR failure determination condition is not satisfied (OFF) (No in step S60), step S60 is repeated.

In step S70, the EGR failure determination unit 60 fully closes the EGR valve 54 (EGR cut). When the EGR valve 54 starts to be fully closed, the EGR gas temperature is received from the EGR temperature sensor 56, and is stored in a storage device of the engine control unit 22 or the like. Then, the process proceeds to step S80.

In step S80, the EGR failure determination unit 60 receives the EGR gas temperature from the EGR temperature sensor 56 after the elapsed time (the elapsed time after startup) from the start of the fully closing operation of the EGR valve 54 in step S70 has passed a predetermined failure determination time ta (for example, about 100 seconds), and determines whether the EGR temperature change amount (the EGR temperature change amount for opening failure determination), which is the difference from the EGR gas temperature stored in the storage device when the EGR valve 54 starts to be fully closed (startup), is greater than or equal to a predetermined opening failure determination value a. The opening failure determination value a may be set to a value higher than an upper limit value of the amount of change in temperature of the EGR gas when the pre-operation is performed for the failure determination time ta with the EGR valve 54 in a fully closed state from the start of the engine 2. As shown in FIG. 5, when the EGR temperature change amount is equal to or larger than the opening failure determination value a (Yes in step S80), the process proceeds to step S90. When the EGR temperature change amount is less than the opening failure determination value a (No in step S80), the process proceeds to step S100.

In step S90, the EGR failure determination unit 60 determines that there is an EGR opening failure, that is, a failure state in which the EGR valve 54 is stuck in an open state. Then, this routine ends.

In step S100, the EGR failure determination unit 60 determines that there is an EGR closing failure, that is, a failure state in which the EGR valve 54 is stuck in a closed state. Then, this routine ends.

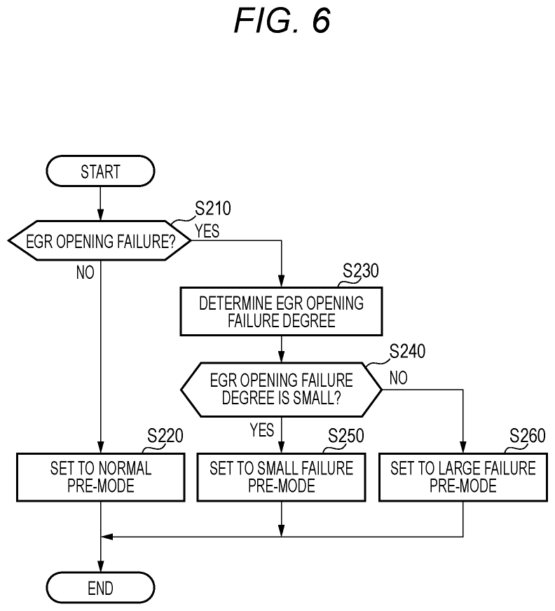

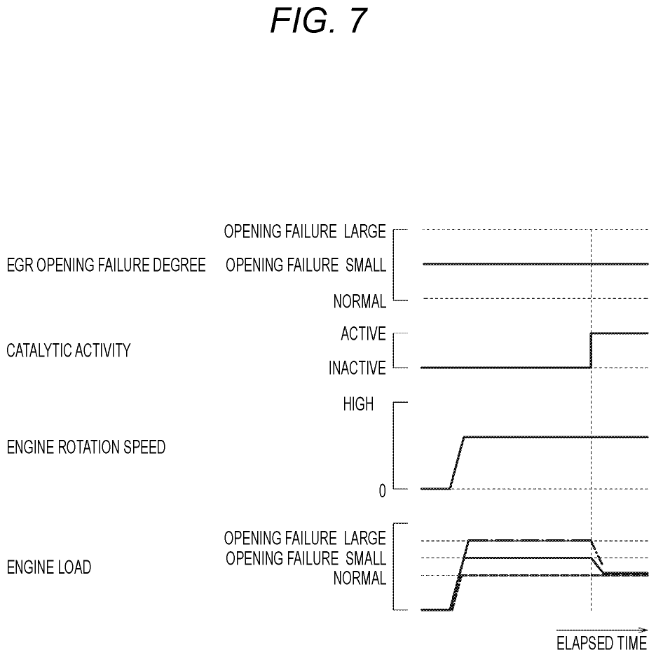

Next, engine load correction control executed by the engine control unit 22 (the engine load correction unit 61) at the time of an EGR opening failure will be described with reference to FIGS. 6 and 7.

FIG. 6 is a flowchart showing a control procedure for the engine load correction control, specifically, a control procedure for determining the operation mode of the engine 2 in the pre-operation. FIG. 7 is a time chart showing an example of the engine load set in a small failure pre-mode. In FIG. 7, a solid line at the engine load indicates the small failure pre-mode, a broken line indicates a normal pre-mode, and a dashed line indicates a large failure pre-mode.

The engine load correction control shown in FIG. 6 is executed when, for example, the EGR opening failure is determined in the EGR failure determination control described above.

As shown in FIG. 6, first, in step S210, the engine load correction unit 61 reads a determination result as to whether the EGR opening failure is determined in the EGR failure determination control described above. When the EGR opening failure is determined (Yes in step S210), the process proceeds to step S230. When the EGR opening failure is not determined (No in step S210), the process proceeds to step S220.

In step S220, the engine load correction unit 61 is set to the normal pre-mode. Then, this routine ends.

The normal pre-mode is one of the operation modes of the engine 2 in the pre-operation immediately after the engine startup, and for example, as shown by the broken line in FIG. 7, the engine 2 is operated at a predetermined low rotation speed and low load from the engine startup. In the present embodiment, the load of the engine 2 set in the normal pre-mode corresponds to a first load according to the present invention, and is a value smaller than the predetermined load set in the series mode.

The pre-operation is performed until the catalyst temperature of the exhaust purification catalyst 58 detected by the catalyst temperature sensor 59 becomes equal to or higher than a predetermined temperature (an activation temperature), and thereafter is an operation in which the engine load corresponds to the required output. In the present embodiment, the normal pre-mode corresponds to a normal warm-up operation mode according to the present invention.

In step S230, the engine load correction unit 61 reads the average value of the amounts of change in intake manifold pressure stored in step 20, and determines an EGR opening failure degree. The EGR opening failure degree is determined according to whether the average value of the amounts of change in intake manifold pressure is equal to or less than a predetermined value.

In this control, as the opening failure of the EGR valve 54, it is assumed that a foreign object gets stuck in the EGR valve 54. In a situation in which a foreign object gets stuck in the EGR valve 54, the actual opening degree does not change from that in a normal state when a control signal (a target opening degree) of the EGR valve 54 is large, but does not become equal to or less than the opening degree Corresponding to the size of the foreign object. Therefore, when the target opening degree is changed between the fully closed state and the fully open state, the actual opening degree of the EGR valve 54 changes to be smaller than that in the normal state, and accordingly, the average value of the amounts of change in intake manifold pressure in step S20 also becomes small. The average value of the amounts of change in intake manifold pressure is correlated with the opening failure degree.

The engine load correction unit 61 determines that the EGR opening failure degree is large when the average value of the amounts of change in intake manifold pressure is equal to or less than a predetermined value set as appropriate, and determines that the EGR opening failure degree is small when the average value of the amounts of change in intake manifold pressure is larger than the predetermined value. Then, the process proceeds to step S240.

In step S240, the engine load correction unit 61 determines whether the EGR opening failure degree determined in step S230 is small. When the EGR opening failure degree is small (Yes in step S240), the process proceeds to step S250. When the EGR opening failure degree is not small, that is, is large (No in step S240), the process proceeds to step S260.

In step S250, the engine load correction unit 61 is set to the small failure pre-mode. In the small failure pre-mode, for example, as indicated by the solid line in FIG. 7, the load of the engine 2 is set larger than that in the normal pre-mode during the pre-operation. Then, this routine ends.

In step S260, the engine load correction unit 61 is set to the large failure pre-mode. In the large failure pre-mode, for example, as indicated by the dashed line in FIG. 7, the load of the engine 2 is set larger than that in the small failure pre-mode during the pre-operation.

Then, this routine ends.

In the present embodiment, the normal pre-mode corresponds to the normal warm-up operation mode according to the present invention, and the small failure pre-mode and the large failure pre-mode correspond to a failure warm-up operation mode according to the present invention. In the present embodiment, the load of the engine 2 set in the small failure pre-mode or the large failure pre-mode corresponds to a second load according to the present invention, is smaller than the predetermined load set in the series mode, and is larger than the first load set in the normal pre-mode.

As shown in FIG. 7, similarly to the normal pre-mode, in both of the small failure pre-mode and the large failure pre-mode, the pre-operation immediately after the engine startup is performed until the catalyst temperature of the exhaust purification catalyst 58 becomes equal to or higher than the predetermined temperature, and thereafter is an operation in which the engine load corresponds to the required output.

The normal pre-mode, the large failure pre-mode, and the small failure pre-mode that are determined in this control and that will be described later are stored even when the engine is stopped and the vehicle power is turned off, and are applied when the engine is started until the next EGR failure determination control is executed.

As described above, in the present embodiment, by the EGR failure determination control, it is determined not only whether the EGR valve 54 fails, but also whether the EGR valve 54 has a closing failure and whether the EGR valve 54 has an opening failure. When it is determined that the EGR valve 54 has an opening failure, the engine load set in the pre-operation immediately after the engine startup is set to be larger than that when the EGR system is in a normal state. Accordingly, even if the EGR valve 54 has an opening failure and the EGR gas excessively flows into the intake passage 51, the engine operation can be stabilized.

In the present embodiment, by performing the pre-operation (the warm-up operation) in which the engine 2 is operated at a predetermined low load immediately before switching from the EV traveling mode to the series mode, it is possible to improve the stability and the exhaust performance of the engine operation immediately after switching to the series mode. Since the vehicle 1 is driven by the motors 4 and 6 during the pre-operation, the traveling performance of the vehicle 1 can be ensured regardless of the control of the engine 2.

Further, since the exhaust passage 52 of the engine 2 is provided with the exhaust purification catalyst 58, when the EGR valve 54 has an opening failure, the engine load is increased in the pre-operation immediately after the engine startup. Accordingly, it is possible to promote the rise in exhaust temperature and increase the catalyst temperature of the exhaust purification catalyst 58, to improve the exhaust purification performance during the pre-operation, and to ensure the exhaust purification performance of the exhaust purification catalyst 58 immediately after the end of the pre-operation. After the pre-operation is completed, that is, after warming up, the operation stability of the engine 2 is improved and the engine temperature is also increased. Therefore, the increase in engine load is not controlled, so that an unnecessary high-load operation can be reduced and the fuel efficiency can be improved.

In the pre-operation, when the temperature of the exhaust purification catalyst 58 rises to a predetermined temperature or higher, the small failure pre-mode and the large failure pre-mode are canceled to be set to the normal pre-mode, and the high-load operation control is ended. Accordingly, the engine load is not increased more than necessary in order to activate the exhaust purification catalyst 58 in the pre-operation, and the fuel efficiency can be improved.

Since the engine speed is controlled to be constant in the pre-operation, the quietness in the pre-operation can be improved.

The EGR failure determination unit 60 and the engine load correction unit 61 not only determine whether the EGR valve 54 has an opening failure, but also determine the degree of the opening failure, such as a small opening failure or a large opening failure, according to the amount of change in intake manifold pressure. Then, depending on the degree of the opening failure, it is distinguished between the small failure pre-mode and the large failure pre-mode. In the small failure pre-mode, the engine load is slightly increased during the pre-operation, and in the large failure pre-mode, the engine load is greatly increased during the pre-operation.

In this way, since the engine load during the pre-operation is set according to the opening degree of the EGR valve 54 when the opening failure determination (the failure determination) is executed, the engine 2 can be appropriately warmed up according to the failure mode of the EGR valve 54.

In the small failure pre-mode and the large failure pre-mode, it is preferable to increase the engine load by increasing the output of the motor generator 9. Accordingly, by increasing the load of the engine 2 during the pre-operation in the opening failure state of the EGR valve 54, it is possible to increase the electric power supplied to the motors 4 and 6 and the in-vehicle battery 11, and to prevent a decrease in state of charge of the in-vehicle battery 11.

When the required output is increased by an accelerator operation or the like during the pre-operation, it is preferable to stop the pre-operation, and to set the engine load according to the required output. Specifically, in the pre-operation, when the exhaust gas recirculation amount set based on the required output of the engine 2 is larger than the sum of the exhaust gas recirculation amount at the time of an opening failure and the amount of increase in the exhaust gas recirculation amount accompanying an increase in the load of the engine 2 by a predetermined amount, it is preferable to stop the warm-up operation.

Accordingly, when the exhaust gas recirculation amount set based on the required output of the engine 2 is larger than the exhaust gas recirculation amount increased as the engine load is increased during the pre-operation in the opening failure state of the EGR valve 54, the engine 2 can be quickly warmed up by operating the engine 2 according to the required output and increasing the load of the engine 2.

The pre-operation is performed at the time of transition from the EV mode to the series mode, and the switching of this traveling mode is determined based not only on the required output but also on the SOC of the in-vehicle battery 11. For example, the EV mode is started when the SOC of the in-vehicle battery 11 becomes equal to or lower than a first predetermined value in the EV mode. The pre-operation described above is set to a second predetermined value that is slightly higher than the first predetermined value. Accordingly, the pre-operation is started before the SOC of the in-vehicle battery 11 becomes equal to or less than the first predetermined value. Therefore, it is possible to execute the EGR failure determination and the engine load control according to the failure before the SOC of the in-vehicle battery 11 switches to the series mode, and to prevent the SOC of the in-vehicle battery 11 from decreasing below the first predetermined value.

During the EGR failure determination control, when the required output increases due to an accelerator operation or the like, the engine 2 escapes from the pre-operation and starts a full-scale operation, and then the required output decreases to the EV traveling possible output or less, it is preferable to continue operating the engine without transitioning to the EV mode, and to transition to the EV mode after the EGR failure determination control has been completed. Accordingly, the EGR failure determination can be continuously completed.

This concludes the description of the present invention, and the present invention is not limited to the embodiment described above.

For example, in the embodiment described above, the operation of the EGR valve 54 is controlled and the opening failure determination for the EGR valve 54 is executed based on the change in temperature and pressure of the EGR gas. Alternatively, the opening failure determination may be executed using only one of the temperature and pressure of the EGR gas, or the opening failure determination may be executed using another method. The degree of the opening failure is determined in two stages. Alternatively, the degree of the opening failure may be determined in one stage, in multiple stages, or linearly. By finely controlling the engine load in the pre-operation according to the degree of the opening failure, it is possible to more effectively stabilize the engine operation while reducing the fuel consumption, and to quickly raise the engine temperature.

In the embodiment described above, the EGR failure determination unit 60 determines whether the EGR valve 54 has an opening failure. Alternatively, the EGR failure determination unit 60 may determine whether the EGR valve 54 has a closing failure. Then, when the EGR failure determination unit 60 determines that the EGR valve 54 has a closing failure, as in the embodiment described above, by increasing the engine load during the pre-operation as compared to that when the EGR valve 54 is normal, it is possible to improve the stability of the engine operation without affecting the driving even if the EGR valve has a closing failure.

The EGR failure determination unit 60 is provided in the engine control unit 22. Alternatively, the EGR failure determination unit 60 may be provided in the hybrid control unit 20, or may be provided in the vehicle 1 independently.

For example, the vehicle 1 according to the embodiment described above is a PHEV vehicle, and the present invention can also be applied to an engine of a HEV vehicle. The present invention can also be applied to engines of a gasoline engine vehicle and a diesel engine vehicle. In addition to the vehicle, the present invention can be applied to an engine including an EGR system.

Although various embodiments are described above with reference to the drawings, the present invention is not limited to these examples. It is apparent to those skilled in the art that various modifications may be conceived within the scope described in the claims, and it is understood that the modifications naturally fall within the technical scope of the present invention. In addition, the components according to the embodiment described above may be freely combined without departing from the spirit of the present invention.

The present application is based on Japanese Patent Application No. 2021-118853 filed on Jul. 19, 2021, and contents thereof are incorporated herein by reference.

### REFERENCE SIGNS LIST

1: vehicle
2: engine
4: front motor (motor)
6: motor (electric motor)
9: motor generator (generator)
11: in-vehicle battery (storage battery)
11a: monitoring unit (state-of-charge estimating unit)
20: hybrid control unit (traveling mode switching control unit)
22: engine control unit (control unit)
50: EGR system (exhaust gas recirculation system)
53: EGR passage (exhaust gas recirculation passage)
54: EGR valve (exhaust gas recirculation valve)
58: exhaust purification catalyst
59: catalyst temperature detection unit (catalyst temperature sensor)
60: EGR failure determination unit (failure determination unit)

1. A control device for a hybrid vehicle, the hybrid vehicle including an engine including an exhaust gas recirculation system configured to guide a part of exhaust gas from an exhaust passage to an intake passage, a storage battery, a generator driven by the engine to generate electric power, an electric motor configured to drive the vehicle by electric power supplied from at least one of the generator and the storage battery, and a traveling mode switching control unit configured to switch, based on a required output required for the vehicle, between a first traveling mode in which the electric motor is driven by electric power supplied from the storage battery with the engine stopped, and a second traveling mode in which the vehicle travels while causing the generator to generate electric power at a predetermined load or larger by a driving force of the operated engine, the control device comprising:
a failure determination unit configured to determine whether an exhaust gas recirculation valve that adjusts a flow rate of the exhaust gas flowing into the exhaust gas recirculation system has a failure; and
a control unit configured to perform a warm-up operation in which the engine is operated at a first load smaller than the predetermined load while the vehicle is driven by the electric motor before switching from the first traveling mode to the second traveling mode, wherein
the warm-up operation has a normal warm-up operation mode in which the engine is operated at the first load when the failure determination unit determines that the exhaust gas recirculation valve does not have the failure, and a failure warm-up operation mode in which the engine is operated at an engine load increased to a second load larger than the first load and smaller than the predetermined load when the failure determination unit determines that the exhaust gas recirculation valve has the failure, and
the control unit stops a control of increasing the engine load regardless of a failure determination since the warm-up operation ends up, and in the second traveling mode after switching, travels the vehicle while causing the generator to generate the electric power at the predetermined load or larger without the control of increasing the engine load.

2. The control device for the hybrid vehicle according to claim 1, wherein
an exhaust purification catalyst is provided in the exhaust passage,
the control device further comprises a catalyst temperature detection unit configured to detect a temperature of the exhaust purification catalyst, and
the control unit ends the failure warm-up operation mode when the temperature of the exhaust purification catalyst becomes equal to or higher than a predetermined temperature during the warm-up operation.

3. The control device for the hybrid vehicle according to claim 1, wherein
the control unit controls a rotation speed of the engine to be constant for a predetermined period of time in the warm-up operation.

4. The control device for the hybrid vehicle according to claim 1, wherein
the failure determination unit estimates an opening degree of the exhaust gas recirculation valve when determining that the exhaust gas recirculation valve has the failure, and
the control unit sets an increased amount of the engine load in the failure warm-up operation mode with respect to the normal warm-up operation mode in accordance with the opening degree of the exhaust gas recirculation valve when determined that the exhaust gas recirculation valve is in the failure.

5. The control device for the hybrid vehicle according to claim 1, wherein
the control unit increases the engine load by increasing at least an output of the generator in the failure warm-up operation mode.

6. The control device for the hybrid vehicle according to claim 1, wherein
during the warm-up operation, when the required output of the engine becomes higher than an output of the engine in the warm-up operation, the control unit forcibly stops the warm-up operation and operatively controls the engine based on the required output of the engine.

7. The control device for the hybrid vehicle according to claim 6, wherein
in the failure warm-up operation mode, when an exhaust gas recirculation amount set based on the required output of the engine is larger than a sum of an exhaust gas recirculation amount at a time of a failure and an increased amount of the exhaust gas recirculation amount depending on an increased amount of the engine load, the control unit stops the failure warm-up operation mode.

8. The control device for the hybrid vehicle according to claim 1, further comprising
a state-of-charge estimation unit configured to estimate a state of charge of the storage battery, wherein
the traveling mode switching control unit switches to the second traveling mode when the state of charge of the storage battery becomes equal to or less than a first predetermined value in the first traveling mode, and
the control unit starts the warm-up operation when the state of charge of the storage battery becomes equal to or less than a second predetermined value higher than the first predetermined value.
